(19) United States
(12) Patent Application Publication
(10) Pub. No.: US 2021/0124190 A1
(43) Pub. Date: Apr. 29, 2021

(54) OPTIMISED PAD HOLDER AND SPECTACLE MOUNT COMPRISING AT LEAST ONE SUCH OPTIMISED PAD HOLDER

(71) Applicant: VISOTTICA INDUSTRIE SPA, Susegana (TV) (IT)

(72) Inventors: Rinaldo Montalban, Venezia (IT); Pierre-Franck Linossier, Mandelieu-La-Napoule (FR); Richard Chene, Neuilly-Sur-Seine (FR); Dominique Delamour, Les Mesnuls (FR); Alain Miklitarian, Paris (FR)

(73) Assignee: VISOTTICA INDUSTRIE SPA, Susegana (TV) (IT)

(21) Appl. No.: 17/080,023

(22) Filed: Oct. 26, 2020

(30) Foreign Application Priority Data
Oct. 29, 2019 (FR) 1912106

(51) Int. Cl. G02C 9/00; G02C 13/00

(52) U.S. Cl. CPC G02C 9/00; G02C 2200/18; G02C 13/001

(57) ABSTRACT

A pad holder for spectacle mounts, the pad holder comprising a fastening part configured to be mounted in a housing of the spectacle mount along an insertion axis X oriented from back to front, the fastening part comprising a closing face comprising an auxiliary groove configured to cooperate with a lens of the spectacle mount in order to lock the pad holder and a mounting face comprising at least one blocking tooth configured to be forced against a wall of the housing during the mounting of the lens.

### TECHNICAL FIELD

The present invention relates to the field of spectacle mounts and, more specifically, so-called “rimmed” mounts which surround the peripheral edge of lenses.

Conventionally, a pair of spectacles is constituted of a spectacle mount in which are mounted solar, viewing or fantasy lenses. The spectacle mount comprises a main frame suited to receiving said lenses, and two ear stems mounted at the lateral ends of said main frame. Each ear stem is connected to the main frame through a hinge which mainly makes it possible to fold/unfold the ear stem. Moreover, the main frame comprises nose pads to improve the comfort of the user while wearing the mount. In practice, the nose clip is formed of the same material as the main frame, in particular made of acetate, whereas the nose pads are made of another material and fastened by bonding according to different methods more or less long and restrictive.

Given the important number of these components, a spectacle mount is long and complex to assemble by a manufacturer or by an optician, which increases the cost thereof. In addition, a spectacle mount being a fashion accessory, it is necessary to design a large number of mount models in order to satisfy all of the desires of users, which represents another drawback.

To eliminate at least some of these drawbacks, a spectacle mount is known from the patent application FR3037154A1 comprising a housing in which is mounted a pad holder. The pad holder is locked in position in said opening during the mounting of the lens. Such an added mounting of the pad holder makes it possible to adapt the shape and the dimension of the pad holder as a function of the needs of the user, his morphology or his aesthetic desires. In addition, for the optician, the mounting of such a pad holder is rapid and practical.

In practice, during insertion, the pad holder is liable to be displaced before the lens is mounted. This positioning defect affects the wearing of the mount and is a source of discomfort. Also, in practice, the optician has to use one hand to hold the pad holder while using the other hand to mount the lens, which is inconvenient and increases the risk of damage.

Furthermore, when the pad holder is locked by the lens, it is liable to be displaced and to come free due to vibrations, which leads to the same drawbacks. An immediate solution to eliminate this displacement would be to carry out an additional bonding or to carry out a locking using an additional part (pin, etc.). However, such a solution cannot be retained given that it increases in a significant manner the cost and the mounting time of such a pad holder.

The aim of the invention is thus to overcome at least some of these drawbacks by proposing a novel mount of which the assembly is easy, rapid and secure while having a reduced manufacturing cost.

### SUMMARY

The invention relates to a pad holder for spectacle mounts, the pad holder comprising a fastening part configured to be mounted in a housing of the spectacle mount along an insertion axis X oriented from back to front, the fastening part comprising:
a closing face comprising an auxiliary groove configured to cooperate with a lens of the spectacle mount in order to lock the pad holder; and
a mounting face comprising at least one projecting blocking tooth configured to be forced against a wall of the housing during the mounting of the lens.

In an advantageous manner, the pad holder is a modular component of which the shape, the colour and the size may be chosen freely. Thanks to the closing face, the opening of the mount is similar to that of a traditional mount when the fastening part is mounted in its housing. An optician may thus mount the lens in a traditional manner, which is advantageous. In an advantageous manner, it is no longer necessary to make the nose pads integral by soldering as in the prior art, which represents an important time saving. A simple translation makes it possible to mount a pad holder when the mount is flat.

Thanks to the projecting blocking tooth, the fastening part comprises a relief which sinks into the wall of the housing during the mounting of the lens in order to improve the engagement of the pad holder. In other words, any phenomenon of sliding is eliminated and the risk of involuntary removal is eliminated.

Preferably, the blocking tooth has a triangular section defining a front face and a rear face. Such a blocking tooth has a pointed end able to penetrate into the material of the wall of the housing during locking. The definition of a front face and a rear face makes it possible, on the one hand, to facilitate insertion and, on the other hand, to prohibit removal.

According to an aspect of the invention, the front face of the blocking tooth is inclined with respect to the insertion axis X by an angle comprised between 100° and 120°. Such an inclination of the front face makes it possible to facilitate insertion by an optician. Minimum effort is required of said optician.

According to another aspect of the invention, the rear face of the blocking tooth is inclined with respect to the insertion axis X by an angle comprised between 85° and 95°. Such an inclination of the rear face makes it possible to prevent any removal. The shape of the blocking tooth opposes any removal, which makes it possible to withstand in an optimal manner vibrations and impacts.

Preferably, the pad holder comprises several blocking teeth configured to be forced against the wall of the housing during the mounting of the lens. The use of several teeth makes it possible to secure in a long-lasting manner the mounting of the pad holder.

In a preferred manner, the fastening part has a transversal section, defined with respect to the insertion axis, that is substantially rectangular with rounded edges. The complementarity of the shapes of the fastening part of the pad holder and of said housing makes it possible to maintain the pad holder stable in its housing prior to its locking by the lens. The blocking teeth form a relief avoiding any unvoluntary removal while being constrained during insertion. The mounting is very secured.

Preferably, the pad holder comprises a nose pad and a linking part connecting the nose pad to the fastening part. Thus, each pad holder may be produced to adapt to the morphology of different nose shapes by simply adapting the linking part and the nose pad, the fastening part remaining advantageously identical between different pad holders.

The invention also relates to a spectacle mount comprising a main frame comprising a rear face intended to be turned towards the user and a front face opposite to the rear face and comprising two openings configured to receive respectively two lenses, at least one opening comprising an inner peripheral edge able to cooperate with an outer peripheral edge of a lens, the inner peripheral edge of said opening comprising at least one housing in which is mounted a pad holder such as described previously, the blocking tooth of the mounting face of the fastening part being in contact with a wall of the housing, said pad holder being configured to be locked in position by said lens during the mounting of the lens in said opening.

In a preferred manner, said inner peripheral edge of the opening comprising a main groove, the auxiliary groove of the closing face is in the continuity of the main groove. Thus, the lens is maintained in a secure manner in a peripheral groove. Preferably, the grooves are aligned to form a continuous overall groove similar to a groove for mounting a mount according to the prior art.

Preferably, the fastening part of the pad holder and said housing have complementary shapes so as to limit clearance and facilitate mounting.

According to an aspect of the invention, the closing face of the fastening part is adapted to ensure the continuity of the peripheral edge of the opening when the fastening part is mounted in its housing.

Preferably, the main frame comprising a rear face intended to be turned towards the user and a front face opposite to the rear face, said housing comprises a front abutment wall configured to block said pad holder. Thus, the fastening part of the pad holder is hidden by the abutment wall, only the frame is visible on the front face. Such an abutment wall is advantageous for limiting the translation of the pad holder during its mounting in the housing. It further makes it possible to define in a precise manner the position of the blocking tooth or teeth to secure the position of the fastening part.

The invention also relates to pair of spectacles comprising a mount such as described previously and at least one lens mounted in an opening and locking in position said pad holder, the blocking tooth of the pad holder being forced against the wall of the housing during the mounting of the lens.

The invention also relates to a method for mounting at least one lens in a spectacle mount such as described previously, the method comprising:
a step of insertion, preferably from back to front, along the insertion axis, of the pad holder into the housing of the inner peripheral edge of an opening, the blocking tooth of the mounting face of the fastening part being in contact with the wall of the housing; and
a step of mounting a lens in said opening in order to force the blocking tooth of the mounting face of the fastening part against the wall of the housing in order to lock said pad holder in position.

Thanks to the invention, a single step of mounting suffices to lock, embed and thus secure in position the lens and the pad holder, which makes it possible to limit in a significant manner the time for mounting a mount. Indeed, the blocking tooth makes it possible to secure the position of the fastening part in the housing without resorting to an added securement means.

### BRIEF DESCRIPTION OF THE DRAWINGS

The invention will be better understood on reading the description that follows, given uniquely as an example, and by referring to the appended drawings given as non-limiting examples, in which identical references are given to similar objects and in which:

FIG. 1 is a schematic representation of a spectacle mount according to the invention with added pad holders;

FIG. 2 is a schematic representation in perspective of a pad holder according to an embodiment of the invention without nose pad;

FIG. 3 is a schematic side representation of the pad holder of FIG. 2;

FIG. 4 is a schematic zoom representation of two blocking teeth of the fastening part of FIG. 3;

FIGS. 5A, 5B and 5C are schematic representations of different types of pad holders;

FIGS. 6 and 7 are schematic representations of a step of insertion of a pad holder into a housing of a mount;

FIG. 8 is a schematic representation of a step of mounting of the lens in the opening of the mount;

FIG. 9 is a schematic representation in section of the pad holder in position locked by the lens.

It should be noted that the figures set out the invention in a detailed manner for implementing the invention, said figures obviously being able to better serve to define the invention if need be.

### DETAILED DESCRIPTION

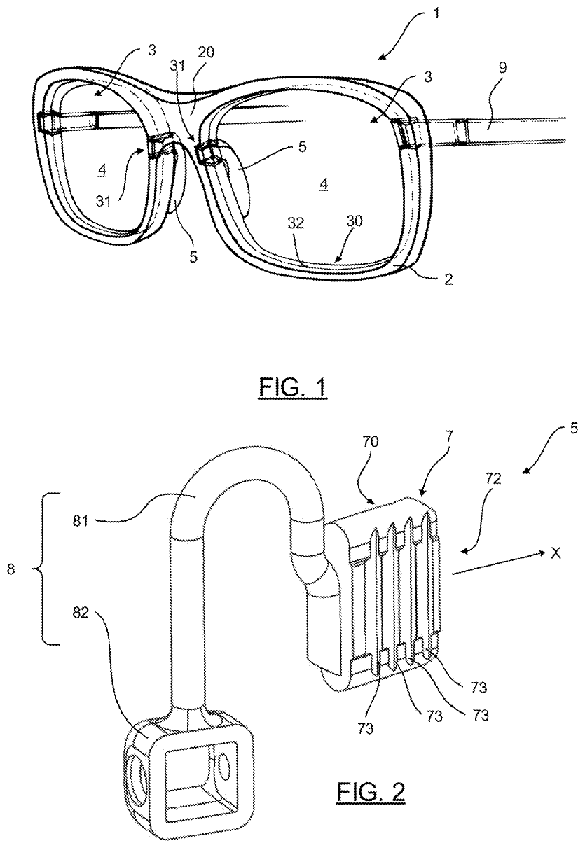

With reference to FIG. 1, a rimmed mount 1 is shown comprising a main frame 2 comprising two openings 3 able to receive respectively lenses 4. In this example, each opening 3 comprises an inner peripheral edge 30 able to cooperate with an outer peripheral edge of a lens 4. Such an opening is also known to those skilled in the art under the designation of rimming.

Still with reference to FIG. 1, the mount 1 comprises two pad holders 5 according to the invention.

In this embodiment, the inner peripheral edge 30 of each opening 3 comprises a housing 31 in which is mounted a pad holder 5. Each pad holder 5 is configured to be locked in position during the mounting of a lens 4 in its opening 3 as will be described hereafter.

In this example, the pad holders 5 are mounted in a definitive manner, for example, the mounting of the lens 4 making it possible to secure the mounting. In a preferred manner, it is not necessary to carry out bonding, soldering or screwing.

The mount 1 has a modular structure comprising several independent components.

Also, if a collection of main frames 2, a collection of pad holders 5 is available, it is possible to assemble a mount 1 of original aesthetic aspect by combining several components of said collections. As will be described hereafter, a collection of pad holders 5 is particularly advantageous for adapting to the different morphologies of the users of the mounts 1.

Moreover, the assembly of the mount 1 is very simple to carry out given that the mounting of the lenses 4 makes it possible to lock the pad holders 5 concomitantly. In an advantageous manner, the mounting of the lenses 4 is similar to the prior art and may thus be carried out in a rapid and practical manner by opticians. The mounting of the pad holders 5 is particularly simple, practical and secure as will be described hereafter.

The different components of the spectacle mount 1 will henceforth be described in detail.

In this example, still with reference to FIG. 1, the main frame 2 comprises two openings 3 suited to receiving lenses 4. The main frame 2 is in this example made of acetate but it goes without saying that other materials could be suitable, in particular, any metal or plastic material. As illustrated in FIG. 1, the main frame 2 is substantially flat but it goes without saying that it could be different, in particular, curved. The main frame 2 comprises a nose clip 20.

In a known manner, the main frame 2 comprises a rear face intended to be turned towards the user and a front face opposite to the rear face. The terms “rear” and “front” will be used hereafter in accordance with this definition.

Each opening 3 comprises an inner peripheral edge 30 able to cooperate with an outer peripheral edge of a lens 4. In this example, still with reference to FIG. 1, the inner peripheral edge 30 comprises a main groove 32 in order to make it possible to lock a lens 4 in a stable manner in the mount 1. In a preferred manner, the main groove 32 has a section having a V shape in order to facilitate the mounting of the lens 4. However, it goes without saying that the section of the groove 32 could have a different shape.

As indicated previously, each inner peripheral edge 30 comprises a housing 31 in which is mounted a pad holder 5. In other words, each housing 31 forms a discontinuity in the inner peripheral edge 30. The result is that the groove 32 of the inner peripheral edge 30 also comprises a discontinuity. In an advantageous manner, when a pad holder 5 is introduced into its housing 31, the peripheral edge 30 is again continuous as is described hereafter.

In this example, each opening 3 comprises a housing 31 at its lower side end for the mounting of a pad holder 5 as illustrated in FIG. 1. In a preferred manner, the housing 31 is positioned at a vertical height less than that of the nose clip 20 of the mount 1, that is to say, at an optimal position for comfort and ergonomics.

In the prior art, it has been proposed to form housings at the level of the nose clip 20 of the main frame 2 in order to benefit from its greater thickness. According to the invention, a housing 31 of small dimensions may be produced and said housing may be positioned in an optimal manner on the main frame 2. It is no longer necessary to form it in a thick portion of the nose clip 20. In this example, the housing 31 comprises a vertical length of the order of 5 mm and a vertical thickness of the order of 1.2 mm.

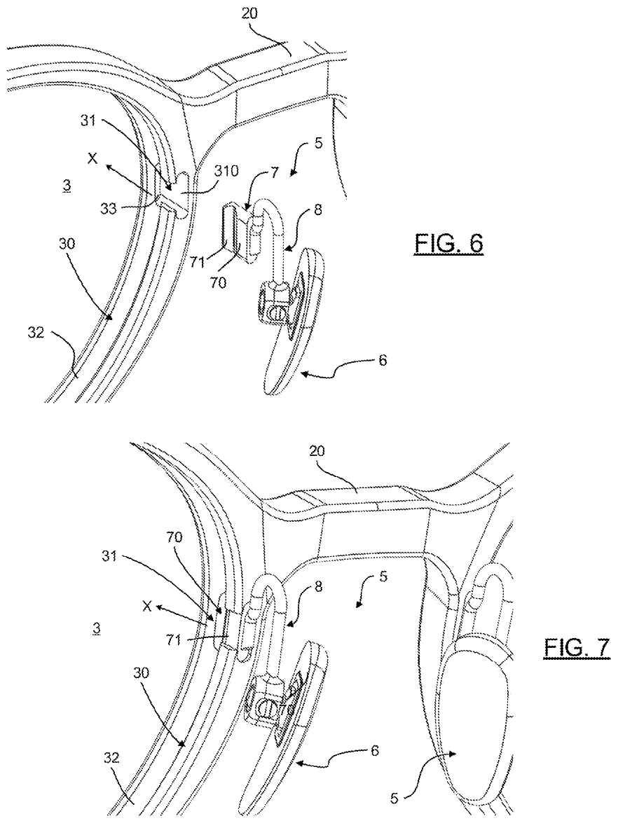

In this example, with reference to FIG. 6, each housing 31 is open from the rear so as to enable the mounting of a pad holder 5 in a housing 31 by translation from back to front along an insertion axis X. Such a mounting is simple to carry out in a reduced time. Such a mounting from back to front is advantageous for an optician who can work flat on the mount 1 from the rear. The risk of deformation or mounting defect is considerably reduced. It goes without saying however that an insertion from the front to the rear is also possible.

In this example, the housing 31 comprises a front abutment wall 33 suited to blocking said pad holder 5 during its translation forwards along the insertion axis X. Such an abutment wall 33 further makes it possible to hide the pad holder 5 when it is situated in its housing 31. In other words, when a pad holder 5 is mounted in a housing 31 comprising an abutment wall 33, it is not visible on the front face of the main frame 2 of the mount 1. The abutment wall 33 makes it possible to define in a very precise manner the position of the pad holder 5 along the insertion axis X, which avoids any mounting defect.

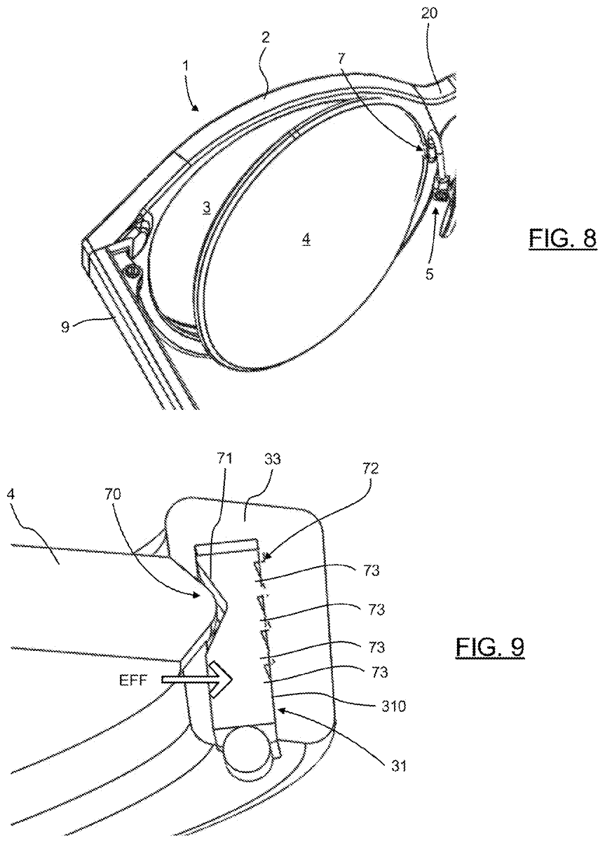

Any type of lens 4 may be used in said mount 1, in particular, a corrective, tinted or fantasy lens or an eyeglass lens. Each lens 4 comprises an outer peripheral edge, preferably bevelled as illustrated in FIG. 8 in order to cooperate with the groove 32 of the openings 3 of the mount 1.

A pad holder 5 according to an embodiment of the invention is represented in a schematic manner in FIG. 6. Each pad holder 5 comprises a nose pad 6, a fastening part 7 intended to be housed in a housing 31 and a linking part 8 connecting the nose pad 6 to the fastening part 7.

As illustrated in FIG. 2, the fastening part 7 of a pad holder 5 has a shape complementary to the housing 31 in which it is mounted in order to facilitate its insertion and to enable a precise mounting, that is to say, free of functional clearance liable to cause vibrations. In a preferred manner, a tenon and mortise link between the pad holder 5 and the housing 31 is particularly suited and simple to implement.

The fastening part 7 extends along the insertion axis X and has a transversal section, defined with respect to the insertion axis X, that is substantially rectangular with rounded edges so as to enable a long-lasting fastening and to limit the formation of projecting angles liable to limit the lifetime of the mounting. Such a shape is advantageous compared to an H shape, which induces important efforts and which necessitates a housing of large dimensions in an important thickness of the mount 1.

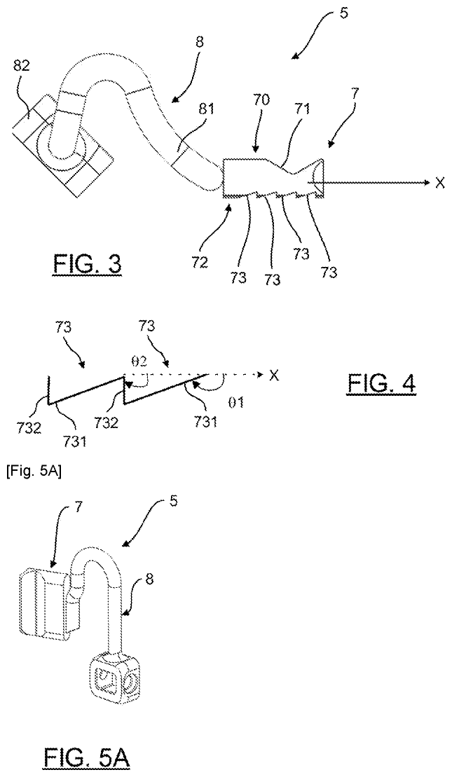

With reference to FIG. 3, the fastening part 7 comprises a closing face 70, or inner face, configured to ensure the continuity of the peripheral edge 30 of the opening 3 when the fastening part 7 is mounted in its housing 31. The closing face 70 is preferably curved in order to hug the shape of the outer peripheral edge of the lens 4. The closing face 70 comprises an auxiliary groove 71 in order to cooperate with the outer peripheral edge of the lens 4. As illustrated in FIG. 7, in mounted position, the auxiliary groove 71 of the closing face 70 extends into the extension of the main groove 32 of the inner peripheral edge 30 of the opening 3 in order to form an overall peripheral groove in which may be mounted the lens 4 as illustrated in FIG. 7.

In a preferred manner, in order to ensure a good compromise between mechanical strength and ergonomics, the length of the fastening part 7, along the insertion axis X, is comprised between 3.3 mm and 3.5 mm. In a preferred manner, the vertical length of the fastening part 7 is comprised between 4.8 mm and 5.2 mm.

With reference to FIG. 2, the fastening part 7 comprises a mounting face 72, or outer face, configured to be in contact with a wall 310 of the housing 31. The mounting face 72 is opposite to the closing face 70 and makes it possible to ensure its precise positioning as will be described hereafter.

In this example, the mounting face 72 comprises several projecting blocking teeth 73 configured to be forced against a wall 310 of the housing 31 (FIGS. 6 and 9) during the mounting of the lens 4, in particular, four. It goes without saying however that the number of blocking teeth 73 could be different. In this example, the blocking teeth 73 are forced against a bottom wall 310 of the housing 31. It goes without saying that other faces of the fastening part 7 could comprise teeth, in particular, an upper face and/or a lower face of the fastening part 7.

More precisely, with reference to FIGS. 3 and 4, each blocking tooth 73 has a triangular section defining a front face 731 and a rear face 732. In this example, the front face 731 of the blocking tooth 73 is inclined with respect to the insertion axis X by an angle θ1 comprised between 100° and 120°. Similarly, the rear face 732 of the blocking tooth 73 is inclined with respect to the insertion axis X by an angle θ2 comprised between 85° and 95°. Thus, the blocking tooth 73 has a front face 731 slightly inclined during insertion, which limits the insertion efforts for the optician. Conversely, the rear face 732 is heavily inclined and makes it possible to increase the mechanical strength rearwards, that is to say, in the sense of removal. Any involuntary removal is thus avoided. A relative displacement of the fastening part 7 in its housing 31 is thus considerably reduced, which improves the vibration resistance

Each blocking tooth 73 makes it possible, thanks to its projecting end, to form a relief for engaging in the wall 310 of the housing 31, which prevents any backwards movement. In an advantageous manner, the projecting end of each blocking tooth 73 makes it possible to penetrate into the material of the wall 310 of the housing 31. The wall 310 of the housing 31 is smooth, without any recess, so that each blocking tooth 73 modifies the shape of the wall 310 during the mounting. The fastening part 7 of a pad holder 5 has a shape complementary to the housing 31. Therefore, during the mounting, the blocking teeth 73 are deformed when the fastening part 7 is pushed axially. The position of the pad holder 5 cannot be modified inadvertently after mounting.

With reference to FIG. 2, the linking part 8 has a stem 81, preferably curved, and a mounting member 82 configured to receive the nose pad 6. The shape, the dimension and the curvature of the stem 81 are preferably adapted to the needs of each user.

The nose pad 6 is mounted on the linking part 8 and may be fastened in a practical manner. In an analogous manner, the shape and the dimension of the nose pad 6 are preferably suited to the needs of each user.

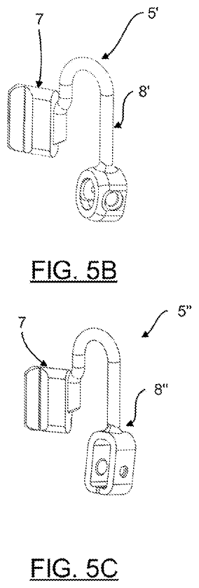

In an advantageous manner, with reference to FIGS. 5A-5C, it is possible to have available a collection of pad holders 5, 5′, 5″ of different shapes, sizes and aspects in order to adapt to the morphology and to the aesthetic preferences of each user. In an advantageous manner, each pad holder 5, 5′, 5″ has fastening parts 7 which are identical but linking parts 8, 8′, 8″ and nose pads (not represented) which are different. Thus, a same main frame 2 may receive in a practical manner pad holders 5, 5′, 5″ which are different.

A method for mounting lenses 4 in the spectacle mount 1 will henceforth be described with reference to FIGS. 6 to 9.

In this exemplary embodiment, an optician firstly selects the components of the mount 1 that he wishes to assemble, that is to say, the main frame 2 and the pad holders 5. It goes without saying that the pad holders 5 of a same mount 1 may be identical or different.

Next, with reference to FIGS. 6 and 7, the optician inserts each pad holder 5 into the housings 31 of the openings 3. To this end, he translates the fastening parts 7 of the pad holders 5 from back to front in the housings 31 along the insertion axis X. With reference to FIG. 7, in mounted position, the closing face 70 of the fastening part extends into the continuity of the inner peripheral edge 30 of the opening 3. Once the pad holders 5 mounted, the inner peripheral edge 30 of each opening 3 is continuous. In this example, it further comprises an overall peripheral groove which is formed in part in the main frame 2 (main groove 32) and in part on the closing faces 70 (auxiliary groove 71) of the pad holders 5. During insertion into the housing 31, the blocking teeth 73 are constrained and the risk of accidental removal is eliminated. In practice, the optician no longer needs to hold the pad holder 5 during the mounting of the lens 4. He may thus use both his hands, which procures a time saving and limits the risk of damage during mounting.

With reference to FIG. 8, the optician next carries out a step of mounting a lens 4 in the opening 3 in order to lock the pad holder 5 mounted in said opening 3. The mounting of the lens 4 is carried out in a manner similar to the prior art, which is practical. The second lens 4 is mounted in the mount in a similar manner.

As illustrated in FIGS. 8 and 9, during the mounting of the lens 4, the lens 4 exerts an effort EFF on the closing face 70 which forces the mounting face 72 against the wall 310 of the housing 31. The result is that the blocking teeth 73 are constrained in the wall 310 of the housing 31 and, preferably, penetrate into the material of said wall 310. A robust engagement is then achieved between the fastening part 7 and the housing 31. If the pad holder 5 is pulled rearwards, the rear face 732 of each blocking tooth 73 blocks any displacement. The mounting of a pad holder 5 is thus robust over time.

Thanks to the invention, a personalised pair of spectacles may be mounted in a rapid and practical manner by an optician. In addition, manufacture is facilitated for eyeglass manufacturers. The production cost of a mount is limited while optimising the possibilities of personalisation. In an advantageous manner, such a pad holder is composite given that it makes it possible to receive a clamping force for the fastening but also enable an engagement.

According to an aspect of the invention, pad holders according to the invention may be associated together (or combined) in order to form a nose clip.

The invention has been described for a main frame comprising openings with a peripheral edge formed in the main frame but the invention also applies to a main frame in which the opening is formed in part by a stretched cable, in particular, made of nylon.

1. A spectacle mount comprising a main frame comprising a rear face intended to be turned towards the user and a front face opposite to the rear face and comprising two openings configured to receive respectively two lenses, at least one opening comprising an inner peripheral edge able to cooperate with an outer peripheral edge of a lens, the inner peripheral edge of said opening comprising at least one housing in which is mounted a pad holder, the pad holder being constituted of a nose pad, a fastening part and a linking part connecting the nose pad to the fastening part, the fastening part being configured to be mounted in the housing of the spectacle mount along an insertion axis X oriented from back to front, the fastening part comprising a closing face comprising an auxiliary groove configured to cooperate with the lens in order to lock the pad holder and a mounting face comprising at least one projecting blocking tooth forced against a wall of the housing during the mounting of the lens.

2. The spectacle mount according to claim 1 wherein the blocking tooth has a triangular section defining a front face and a rear face.

3. The spectacle mount according to claim 2 wherein the front face of the blocking tooth is inclined with respect to the insertion axis X by an angle comprised between 100° and 120°.

4. The spectacle mount according to claim 2 wherein the rear face of the blocking tooth is inclined with respect to the insertion axis X by an angle comprised between 85° and 95°.

5. The spectacle mount according to claim 1, wherein the fastening part has a transversal section, defined with respect to the insertion axis, that is substantially rectangular with rounded edges.

6. The spectacle mount according to claim 1, wherein the mounting face comprises several projecting blocking teeth.

7. The spectacle mount according to claim 1, wherein the wall of the housing is smooth, without any recess.

8. The spectacle mount according to claim 1, wherein said inner peripheral edge of the opening comprising a main groove, the auxiliary groove of the closing face is in the continuity of the main groove.

9. The spectacle mount according to claim 1, wherein the fastening part of the pad holder and said housing have complementary shapes.

10. A pair of spectacles comprising the mount according to claim 1 and at least one lens mounted in an opening and locking in position said pad holder, the blocking tooth of the pad holder being forced against the wall of the housing during the mounting of the lens.

11. A method for mounting at least one lens in the spectacle mount according to claim 1, the method comprising:
a step of insertion, preferably from back to front, along the insertion axis, of the pad holder into the housing of the inner peripheral edge of an opening, the blocking tooth of the mounting face of the fastening part being in contact with the wall of the housing; and
a step of mounting a lens in said opening in order to force the blocking tooth of the mounting face of the fastening part against the wall of the housing in order to lock said pad holder in position.
